(19) United States
(12) Patent Application Publication
(10) Pub. No.: US 2005/0281162 A1
(43) Pub. Date: Dec. 22, 2005

(54) Laser drive system reduced EMI noise

(76) Inventors: Yuki Nagaoka, Ibaraki City (JP); Hiroshi Yasuda, Osaka (JP)

Correspondence Address: YUKI NAGAOKA, 18-27 FUNAKI-CHO, IBARAKI CITY, OSAKA, JP

(21) Appl. No.: 11/153,840

(22) Filed: Jun. 16, 2005

(30) Foreign Application Priority Data
Jun. 21, 2004 (JP) 183147/2004

(51) Int. Cl. G11B 7/00

(52) U.S. Cl. 369/53.12; 369/53.1; 369/53.11

(57) ABSTRACT

In optical disc drive, laser diode is used, and also HFM (High Frequency Module) oscillator is used to reduce laser mode hopping noise. Big EMI noise is radiated by the HFM current for optical noise reduction, or by the switching current for write-strategy of recording. Then conventionally, shield was required in order to reduce EMI noise radiated by the current driving a laser diode. By giving a jitter to the HFM signal superimposed to the current of laser diode or switching signal by write-strategy for recording, a spectrum is diffused and the peak value of an EMI noise is reduced.

### BACKGROUND OF THE INVENTION

1. Field of the Invention

This invention is applicable both for laser drive unit, optical head, and optical disk drive equipment, to irradiating laser light when playing back or recording data on optical discs, such as a compact disk and DVD.

2. Description of the Related Art

Recently laser diode is used for the laser light emitting element of optical disk drive equipment because of small size and low power consumption, but when a laser diode is used as a light source of optical disk drive equipment, the reflected light from an optical disc interferes in the laser oscillation mode of a laser diode, and an optical noise arises. The high-frequency-current superposition method that superimposes AC current of the high frequency from a high-frequency-current drive circuit on DC current to a laser diode which is known as the optical noise reduction method. However, when high frequency current was superimposed, which came with problem of big EMI (Electro Magnetic Interference) noise occurred.

The LD Drive output the Write power as Write-Strategy waveform to switch the current flow through the laser diode when recording data on optical disc, the period even it is not so damage but the problem which is a laser diode that the fundamental wave and harmonics of the switching still became a big EMI noise also had a laser light emitting element.

there are some method to reduce EMI noise which is show up at referenced patent document 1 and a referenced patent document 2.

According to a referenced patent document 1, an optical head is comprising a laser diode and some of electronic parts mounted on circuit board, these parts is connected to laser diode in between.

a case of a conductive material surrounding the electronic circuit part mounted in the circuit board, a object lens drive unit which condenses the optical beam from

a laser diode to a optical spot on a disk.

a pedestal in which the semiconductor laser, the circuit board, the case, and the object lens drive were hold.

a shaft which can be slide for the pedestal and fixed to the traverse base.

Also the box is equipped with the spring part by which a force is made to act the shaft with a shield function.

According to this, the case is characterized by having the spring part on which force is made to act to a shaft with a shield function, and the EMI noise is reduced by the shield function of a case.

According to a referenced patent document 2, the board unit for an optical head is comprising a flexible printed wiring board, an optical element by which optical surface were attached in the surface side of the flexible printed wiring board by the terminal part toward the back side of the flexible printed wiring board, besides a high frequency superposition circuit also mounted on the flexible printed wiring board, and a shielding case.

the shielding case is attached to cover on the opposite side of optical surface of the optical element and terminal to the surface side of the flexible printed wiring board of the optical element block. It is bent so that the surface sides of the flexible printed wiring board of the optical element block and the high frequency superposition circuit part may face each other. The flexible printed wiring board is next to the high frequency superposition circuit and both is located inside the shielding case. The flexible printed wiring board between the above-mentioned optical element and a high frequency superposition circuit is the flexible printed wiring board unit characterized by being located in a shielding case among the above-mentioned flexible printed wiring boards.

According to this, EMI is reduced by attaching optical element towards the back side of the flexible printed wiring board, fixing by the surface side, making a flexible printed wiring board further crooked, so that the surface side may become inside, and making it arrange in a shielding case.

However, since an EMI noise is made not to be emitted outside by shielding in any case, there was a fault that mechanism is restrictions to occur and cost is needed for shield.

Reference Document:

1. Japan Patent Publication Number H11-154334

2. Japan Patent Publication Number 2000-322754

### SUMMARY OF THE INVENTION

The problem we want to solve is that, a shield required in order to reduce an EMI noise, then mechanism restrictions and cost of a shield required.

By giving a jitter to the high frequency superposition signal which is superimposed by the current to a laser diode and becomes the origin of an EMI noise, and the switching signal by write-strategy at the time of record, this invention diffuses a spectrum and reduce the peak value of an EMI noise.

In order that the spectrum of an EMI noise may diffuse, a laser drive, an optical head, and an optical disk drive equipment of this invention in order to give a jitter to a high frequency superposition signal and the switching signal by write-strategy at the time of record, and the peak level of radiation may reduce them, a shield becomes unnecessary, therefore the mechanism restrictions of them are lost, and the advantage that the cost for shielding also becomes unnecessary and the cost reduction of it can be carried out is.

In order to reduce the peak level of an EMI noise, reduction of an EMI noise was realized by adding a jitter to the output waveform of a high frequency superposition circuit at the time of record mark un-forming at the time of reproduction and record without the shield by adding a jitter to the output waveform of a write-strategy generating circuit, and diffusing the spectrum of an EMI noise at the time of record.

### BRIEF DESCRIPTION OF THE DRAWINGS

This invention is described with particularity in the appended claims. The above and further advantages of this invention may be better understood by referring to the following description taken in conjunction with the accompanying drawings, in which:

FIG. 1 is a block diagram of an example 1 of the optical disk drive equipment of this invention.

FIG. 2 is an example 1 of jitter addition method to the high frequency signal used for the equipment of this invention.

FIG. 3 is an example 2 of jitter addition method to the high frequency signal used for the equipment of this invention.

FIG. 4 is an example 3 of jitter addition method to the high frequency signal used for the equipment of this invention.

FIG. 5 is an explanation figure of the effect of this invention.

FIG. 6 is a block diagram of an example 2 of the optical disk drive equipment of this invention.

FIG. 7 is an explanation figure of write-strategy.

FIG. 8 is a block diagram of example 1 of a jitter addition method to the write-strategy output used for the equipment of this invention.

FIG. 9 is a block diagram of example 2 of a jitter addition method to the write-strategy output used for the equipment of this invention.

FIG. 10 is an explanation figure of an example 2 of the jitter addition method to the write-strategy output used for the equipment of this invention.

FIG. 11 is a block diagram of an example 3 of the optical disk drive equipment of this invention.

FIG. 12 is a block diagram of example 3 of a jitter addition method to the write-strategy output used for the equipment of this invention.

FIG. 13 is a block diagram of example 1 of a jitter signal generator used for the equipment of this invention.

FIG. 14 is an explanation figure of example 1 of a jitter signal generator used for the equipment of this invention.

FIG. 15 is a block diagram of example 2 of a jitter signal generator used for the equipment of this invention.

FIG. 16 is an explanation figure of example 2 of a jitter signal generator used for the equipment of this invention.

### DESCRIPTION OF THE PREFERRED EMBODIMENTS

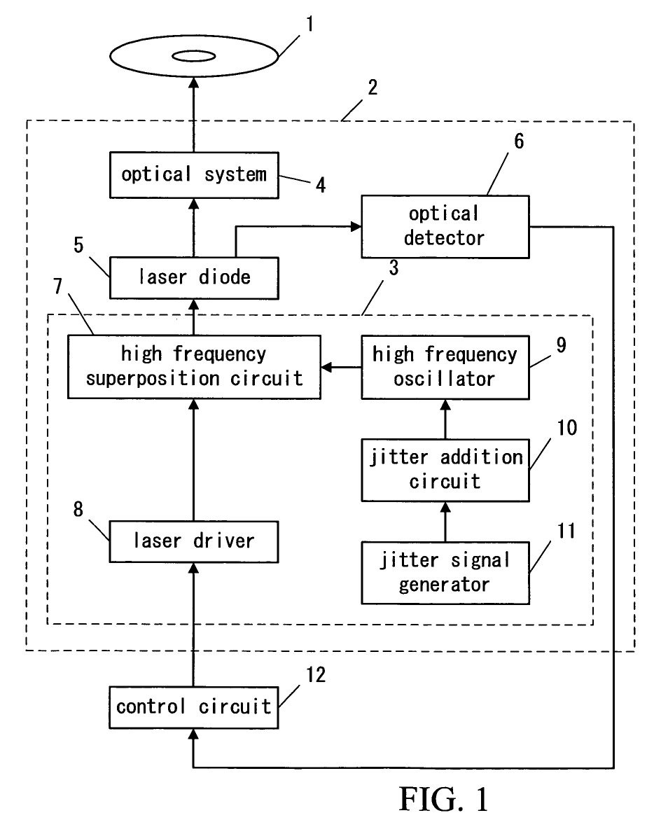

FIG. 1 is a block diagram of an example 1 of the optical disk drive equipment of this invention.

Number 1 is an optical disc, 2 is an optical head, 3 is a laser drive unit, 4 is an optical system, 5 is a laser diode, 6 is an optical detector, 7 is a high frequency superposition circuit, 8 is laser driver, 9 is a high frequency oscillator, 10 is jitter addition circuit, 11 is a jitter signal generator, 12 is a control circuit.

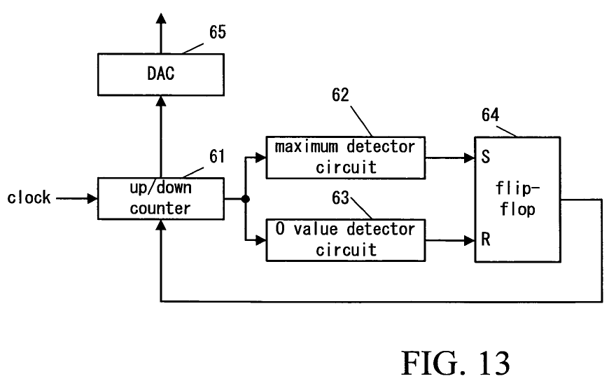

Thus, in the constituted optical disk drive equipment, it is condensed by an optical system 4 and the light emitted from the laser diode 5 is irradiated by the optical disc 1. The part of the light which emitted light from the laser diode 5 is changed into an electric signal with an optical detector 6 as a monitor signal for control of luminescence power, is controlled by a control circuit 12 to become the value as which the monitor signal for control was determined, and drives a laser diode 5 through the laser drive unit 3. It consists of the laser driver 8, the high frequency superposition circuit 7, a high frequency oscillator 9, a jitter addition circuit 10, and a jitter signal generator, the jitter generated in the jitter signal generator 11 of the after-mentioned (FIG. 13-16) carries out the frequency modulation of the high frequency signal generated by the jitter addition circuit 10 in the high frequency oscillator 9, a jitter is given to the laser drive unit 3.

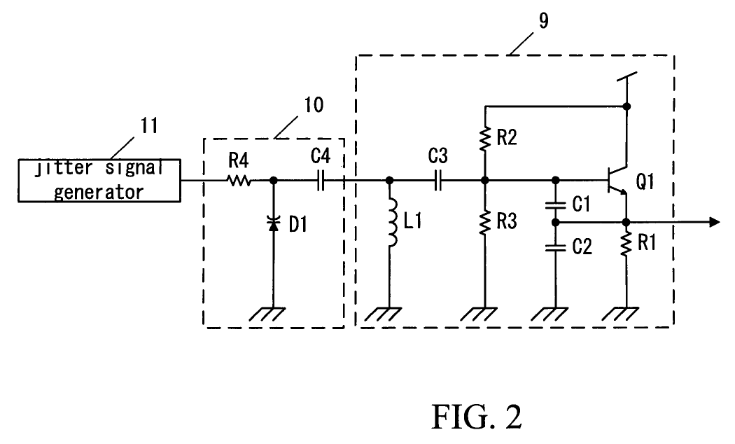

FIG. 2 is an example 1 of the jitter addition method to the high frequency signal used for the equipment of this invention.

Number 9 is a high frequency oscillator, 10 is a jitter addition circuit, 11 is a jitter signal generator, Q1 is a transistor, R1-4 are resistances, C1-4 are capacitors, L1 is a coil, and D1 is a variable capacitance diode,

A collector is connected to a power supply as a collector grounding type amplifier Q1. Load resistance R1 is connected to emitter, and bias voltage is given to a base by resistance division of R2 and R3. A resonant circuit consists of series circuits of C1 and C2 via the capacitor C3 for a direct-current cut L1. The Colpitz oscillator circuit which returns from emitter of Q1 between C1 and C2 is constituted, and the electric capacity of the amount diode D1 of good changes is further added to the resonant circuit in parallel with the in-series capacity of C1 and C2 via the capacitor C4 for a direct-current cut L1. The output of the jitter signal generator 11 is applied via R4, since the capacity value of D1 changes according to a jitter signal, resonance frequency changes and, as for D1, the frequency modulation of the high frequency signal is carried out by a jitter signal.

Moreover, although the Hartley type may be used although the Colpitz type explained the oscillating circuit here, a emitter grounding type or a common base type may be used although the collector grounding type explained the grounded type, and the bipolar transistor explained the transistor, it is the same also with FET or other amplification elements.

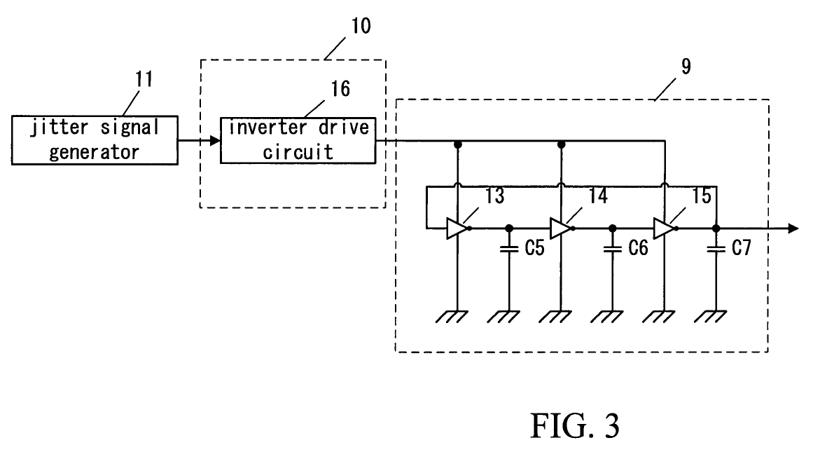

FIG. 3 is an example 2 of jitter addition method to the high frequency signal used for the equipment of this invention.

Number 9 is a high frequency oscillator, 10 is a jitter addition circuit, 11 is a jitter signal generators, 13, 14, and 15 is inverters, 16 is a inverter drive circuit, and C5, C6 and C7 are capacitor.

The oscillating circuit which each output is connected to the input of the following stage in the shape of a ring, and C1, C2, and C3 for delay are connected to each output, and will oscillate an inverter 13, an inverter 14, and an inverter 15 on the frequency from which total of delay of each inverter becomes 180 phase delay if the power supply is connected to the inverter drive circuit 16 and odd inverters are connected in the shape of a ring in this way is constituted. It was equivalent to the jitter addition circuit 10, and has given variable power supply current or power supply voltage to the inverter 13, the inverter 14, and the inverter 15, and its delay is large, when the power supply current is large, the current and delay by C5, C6, and C7 of the inverter drive circuit 16 are small and its power supply current is small. When ON resistance of an inverter 14 and an inverter 15 changes with power supply voltage, when power supply voltage is low, since ON resistance is high, delay is large [since ON resistance is small when power supply voltage is high, the ON resistance and delay by C5, C6, and C7 are small, and], when power supply voltage is given. Although C5, C6, and C7 for delay are written here, if the input gate capacity of parasitism of an inverter 13, an inverter 14, and an inverter 15 is used, there will be no necessity specially. If the power supply current or power supply voltage supplied to the inverter drive circuit 16 with the output of a jitter signal generator is changed, since the frequency from which phase delay becomes 180 degrees will change, the frequency modulation of the high frequency signal is carried out by a jitter signal.

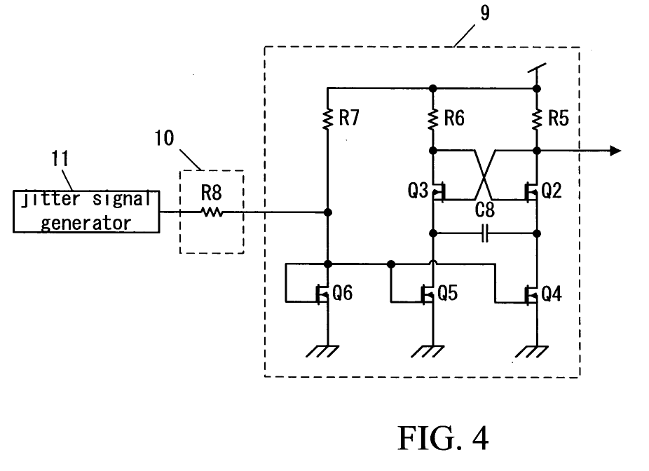

FIG. 4 is an example 3 of jitter addition method to the high frequency signal used for the equipment of this invention.

Number 9 is a high frequency oscillator, 10 is a jitter addition circuit, 11 is a jitter signal generator, Q2, Q3, Q4, Q5, and Q6 are N channel MOS types FETs, R5, R6, R7 and R8 are resistances, and C8 is a capacitor.

The high frequency oscillator 9 which is called sauce knot-pattern multi-vibrator by Q2, Q3, R5, R6, and C8 is constituted. The current supplied to Q2 and Q3 is supplied in the source of current of Q4 and Q5, the mirror of the current which flows through the current value into R7 and Q6 is carried out in the mirror circuit of Q4 and Q5, and oscillation frequency is decided by the mirror current and the capacity value of C8. In order that the output of the jitter signal generator 11 may pour in current between R7 and Q6 through R8, R8 becomes the jitter addition circuit 10, and since oscillation frequency is decided by the mirror current which changes with jitter signals, the frequency modulation of the high frequency signal is carried out by a jitter signal.

Here, although MOS type FET of N channels explained, even if a case of the operation is MOS type FET of P channels, it is junction type FET, and it is a bipolar transistor, it can be constituted similarly.

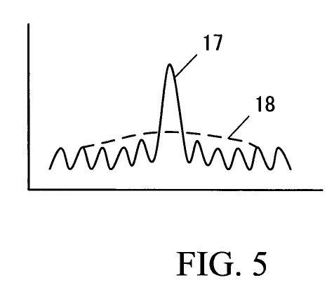

FIG. 5 is an explanation figure of the effect of this invention.

A horizontal axis is frequency and a vertical axis is radiation field intensity. 17 is a radiation level when not giving a jitter to the conventional high frequency which carries out high frequency superposition, and generates a big peak in superposition frequency. 18 is a radiation level at the time of giving a jitter to the superposition frequency of this invention and applying frequency modulation, since a spectrum distributes, a peak level falls, the disturbance to other apparatus is reduced remarkably, and needlessness or simplification can do a shield.

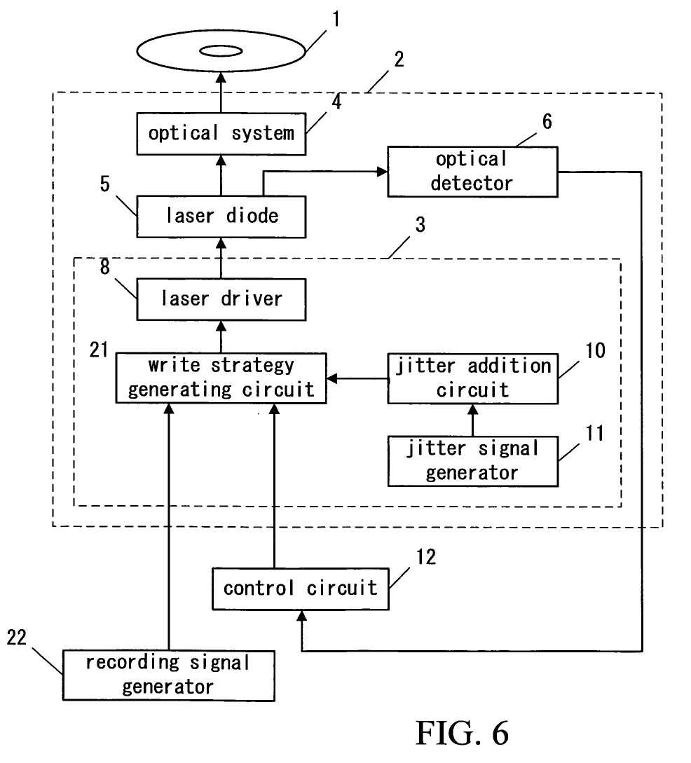

FIG. 6 is a block diagram of an example 2 of the optical disk drive equipment of this invention.

Number 1 is an optical disc, 2 is an optical head, 3 is a laser drive unit, 4 is an optical system, 5 is a laser diode, 6 is an optical detector, 8 is a laser driver, 10 is a jitter addition circuit, 11 is a jitter signal generator, 12 is a control circuit, 21 is a write-strategy generating circuit, and 22 is recording signal generator.

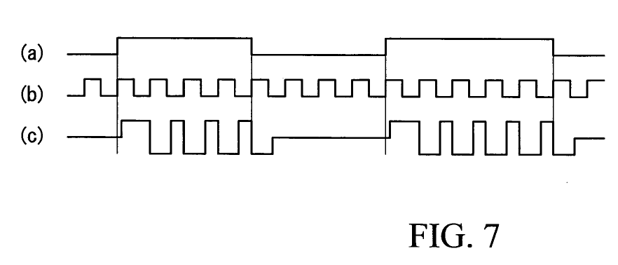

FIG. 7 is an explanation figure of write-strategy.

(a) is a recording signal, (b) is a record clock, (c) is a write-strategy output.

Write-strategy indicated here is an over-write type waveform, and in the portion which forms a mark, a multi-pulse has occurred, in the space part which does not form a mark, the signal of elimination power has occurred.

Operation at the time of recording on an optical disc 1 is explained using FIG. 6 and FIG. 7. First, if a recording signal (a) and a record clock (b) are outputted from the recording signal generating circuit 22 and it is inputted into the write-strategy generating circuit 21, the write-strategy output (c) which becomes the origin of the optical power waveform of the laser diode 5 when recording on an optical disc 1 will be outputted from the write-strategy generating circuit 21. A write-strategy output (c) is inputted into the laser driver 5, drives a laser diode 5, and is irradiated by the disk 1 through an optical system 4, and a recording signal is recorded. A part of light outputted from a laser diode 5 is changed into an electric signal with an optical detector 6 as a monitor signal for control of luminescence power, and it is controlled by a control circuit 12 to become the value as which the monitor signal for control was determined. Furthermore, in order that switching of the laser drive current by a write-strategy output (c) may prevent a big EMI noise from occurring, a jitter signal occurs in the jitter signal generator 11, a jitter is added to a write-strategy output (c) in the jitter addition circuit 10, the spectrum of an EMI noise is spread, and a peak level falls.

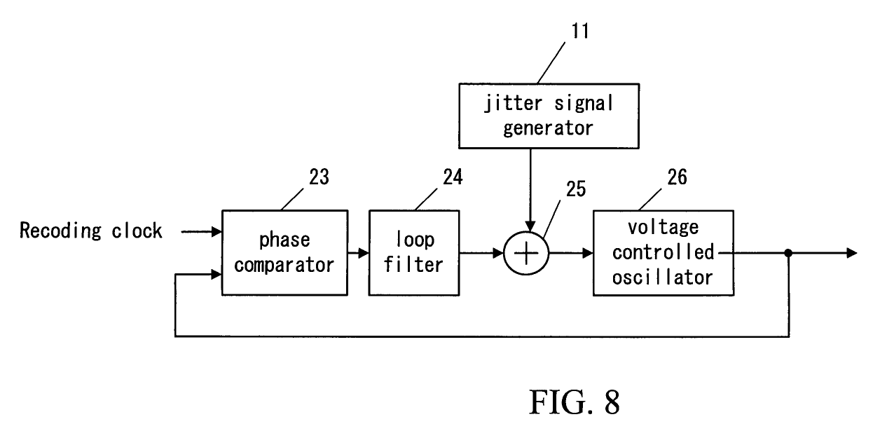

FIG. 8 is a block diagram of example 1 of a jitter addition method to the write-strategy output used for the equipment of this invention.

Number 11 is a jitter signal generator, 23 is a phase comparator, 24 is a loop filter, 25 is an adding machine, and 26 is a voltage controlled oscillator.

In FIG. 8, since the output of the record clock (b) from the recording signal generating circuit 22 and a voltage controlled oscillator 26 is inputted into the phase comparator 23, phase comparison is carried out and the output is inputted into a voltage controlled oscillator 26 via a loop filter 24 and an adding machine 25, the output of a voltage controlled oscillator 26 constitutes PLL used as the signal by which the phase lock was carried out on the record clock (b). Since the jitter signal from the jitter signal generator 11 is added to the output of a loop filter 24 with an adding machine 25 at this time, the output of a voltage controlled oscillator 26 serves as a signal with a jitter. If a write-strategy signal is generated based on this signal, a jitter will be added also to a write-strategy signal.

Here, if the write-strategy generating circuit 21 needs the clock of the integral multiple of a record clock, and the output of a voltage controlled oscillator 26 is divided by divider and it inputs into the phase comparator 23, the clock of divide ratio times of a record clock can be obtained.

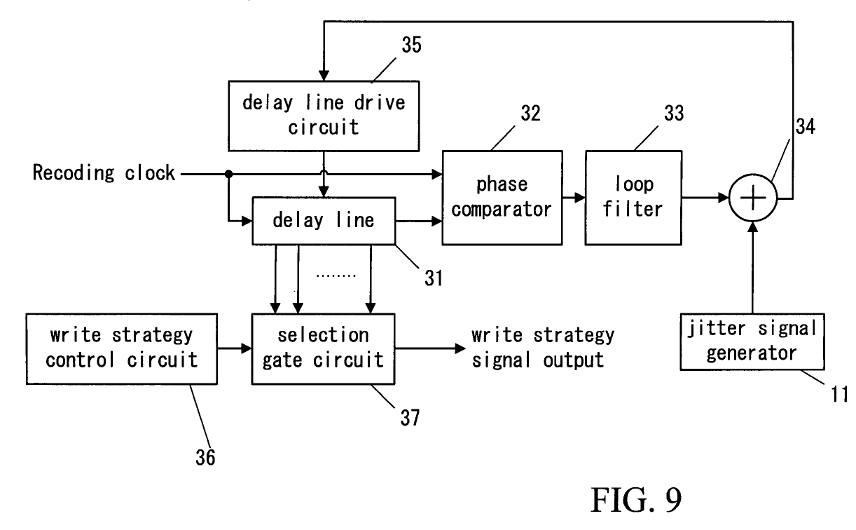

FIG. 9 is a block diagram of example 2 of a jitter addition method to the write-strategy output used for the equipment of this invention.

Number 11 is a jitter signal generator, 31 is a delay line, 32 is a phase comparator, 33 is a loop filter, 34 is an adding machine, 35 is a delay line drive circuit, 36 is a write-strategy control circuit, and 37 is a selection gate circuit.

A delay line 31 consists of buffers of number n for delay and it lets all the buffers for delay pass, only about 1 cycle of a record clock (b) will be delayed. For example, if delay time of one buffer for delay is set to 0.3 ns for the cycle of a record clock (b) for 30 ns, when it lets the buffer for delay of the number of n=100 pass, it will be behind by one cycle of a record clock (b) exactly.

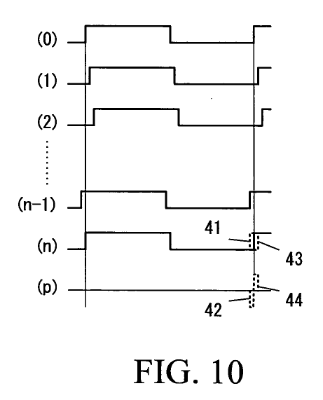

FIG. 10 is an explanation figure of the block diagram of FIG. 9

(0) is a input signal of the delay line 31 and the same as a record clock (b), (1), (2), . . . (n−1), and (n) are the output signals through the buffer for delay of the number of stages in a parenthesis, and (p) is a phase comparison output from the phase comparator 32.

When the delay time of n delay lines is late by one cycle of a record clock (b) exactly, a phase comparison output (p) is not outputted, but delay time is small, and it progresses like 41, negative is outputted like 42, and a phase comparison output (p) has large delay time, and it late like 43, positive is outputted like 44.

Operation is explained using FIG. 9 and FIG. 10.

The phase comparison output (p) of the phase comparator 32 is smoothed, and will be carried out with a loop filter 32, the delay line drive circuit 35 will be supplied through an adding machine 34, and the power supply voltage of the buffer for delay of the delay line 31 will be controlled. Thus, if constituted, when the delay time of the buffer for delay is small, negative will be outputted to a phase comparison output (p). The voltage from the delay line drive circuit 35 falls, and the delay time of the buffer for delay becomes large. Moreover, when the delay time of the buffer for delay is large, positive is outputted to a phase comparison output (p). The voltage from the delay line drive circuit 35 goes up, and the feedback loop that the delay time of the buffer for delay becomes small is constituted, and it is controlled so that the output of the delay line 31 always becomes 1 cycle delay to a record clock (b). By doing in this way, the arbitrary delay waveforms for write-strategy can be obtained without using a high-speed clock, and a required write-strategy waveform is decided in the write-strategy control circuit 36 according to a recording signal (a), and the selection gate of the pulse from which delay from the delay line 31 to which delay is outputted as a write-strategy output (c) is carried out by the selection gate circuit 37, and it is outputted. At this time, by adding the jitter output from the jitter signal generator 11 to the output of a loop filter 33 with an adding machine 34, a jitter is added to the delay line 31 via a delay line drive circuit, and a jitter is added to a write-strategy output (c).

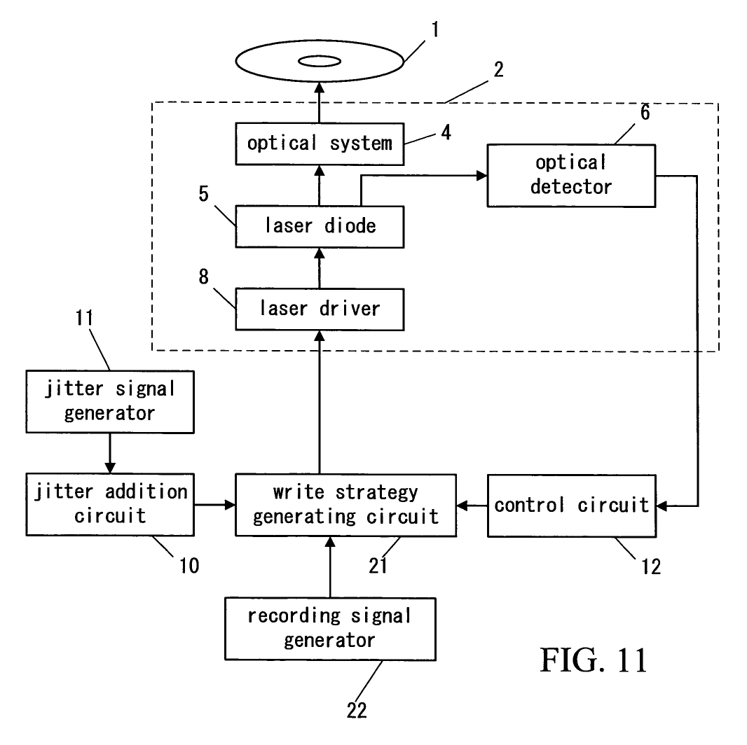

FIG. 11 is a block diagram of an example 3 of the optical disk drive equipment of this invention.

Number 1 is an optical disc, 2 is an optical head, 4 is an optical system, 5 is a laser diode, 6 is an optical detector, 8 is a laser driver, 10 is a jitter addition circuit, 11 is a jitter signal generator, 12 is a control circuit, 21 is a write-strategy generating circuit, and 22 is recording signal generator.

This is an example that a write-strategy generating circuit 21 for record is put on the circuit block side of optical disk drive equipment instead of in the optical head 2.

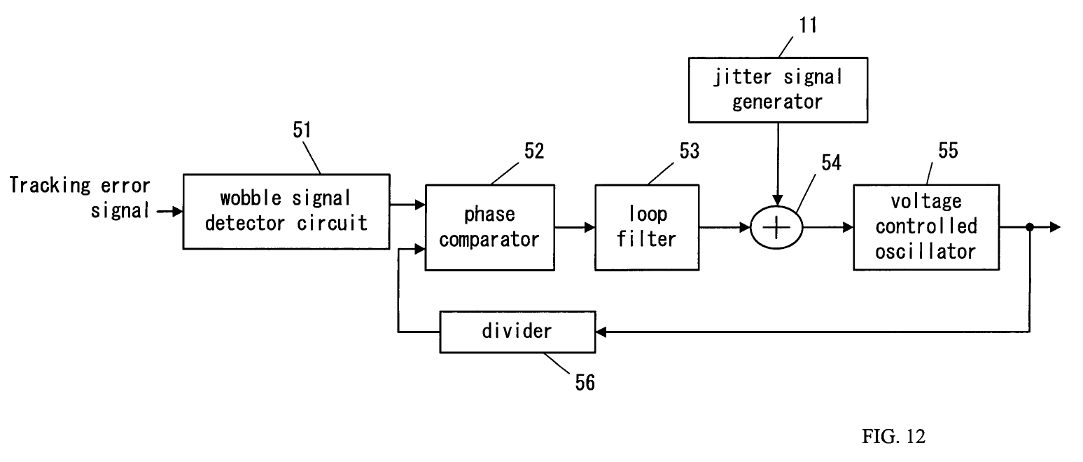

Although the method of FIG. 8 and the method of FIG. 9 can also be used for the method of adding a jitter to a write-strategy output, the method of FIG. 12 can be further used as method of example 3.

FIG. 12 is a block diagram of example 3 of a jitter addition method to the write-strategy output used for the equipment of this invention.

Number 11 is a jitter signal generator, 51 is a wobble signal detector circuit, 52 is a phase comparator, 53 is a loop filter, 54 is an adding machine, 55 is a voltage controlled oscillator, and 56 is a divider.

In FIG. 12, the tracking error signal is inputted into the wobble signal detector circuit 51.

The track wobble signal included in a tracking error signal is formed into 2 values, and is inputted into the phase comparator 52. Phase comparison is carried out with the output which divided the voltage controlled oscillator 55 by divider 56, it is smoothed with a loop filter 53, the PLL circuit inputted into a voltage controlled oscillator 55 through an adding machine 54 is constituted, and the record clock which synchronized with the track wobble is generated. For example, when generating 186 record clocks per track wobble, the divide ratio of divider 56 is set as 186. Thus, although the method of FIG. 8 can be used for the generated record clock and a jitter can also be added, the record clock to which the direct jitter was added can be obtained by adding the jitter signal of the jitter signal generator 11 to the output of a loop filter 53 with an adding machine 54 like the case of the operation of FIG. 12.

FIG. 13 is a block diagram of example 1 of a jitter signal generator used for the equipment of this invention.

Number 61 is an up/down counter, 62 is a maximum detector circuit, 63 is a zero value detector, 64 is a flip-flop of a set and reset type, and 65 is a DAC (Digital to Analog Converter).

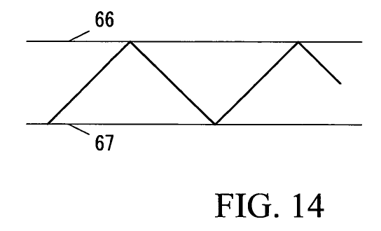

FIG. 14 is an explanation figure of FIG. 13 case of the jitter signal generator 11 (FIG. 13) used for the equipment of this invention.

This is the figure of the output of the up/down counter 61, and 66 is the maximum value of the up/down counter 61, and 67 is zero value of the up/down counter 61.

Using FIG. 13 and FIG. 14, operation of the jitter signal generator 11 of this case of the operation is explained.

At the up/down counter 61, first, the output and record clock of a high frequency oscillator, Or if clocks, such as a system clock oscillated with crystal, are inputted, a rise count is carried out with a clock at first, the value goes up and maximum 66 is reached It is detected that it is maximum in the maximum detector circuit 62, it is inputted into S (set) terminal of a flip-flop 64, a flip-flop 64 is set, and the output is inputted into the up/down change input terminal of the up/down counter 61, and changes to a down count. If it does so, the down count of the next is carried out with a clock, the value falls, if zero value 67 is reached, it will be detected that it is zero value in zero value detector circuit 63, it will be used as R (reset) terminal of a flip-flop 64, a flip-flop 64 is reset, and the output is inputted into the up/down change input terminal of the up/down counter 61, and changes to a rise count. Thus, from the up/down counter 61, the chopping sea of a digital signal is outputted, it is changed into the chopping sea of an analog signal with the DAC 65, and the chopping sea is used as a jitter signal.

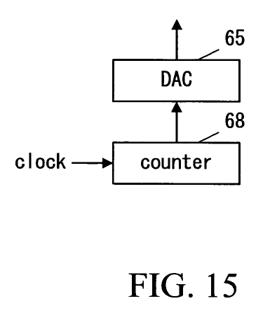

FIG. 15 is a block diagram of the 2nd case of the operation of the jitter signal generator 11 used for the equipment of this invention,

68 is a counter and 65 is a DAC.

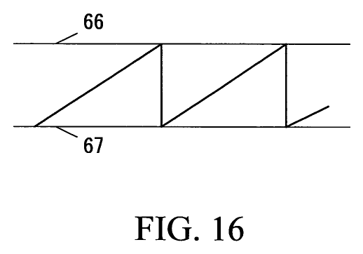

FIG. 16 is an explanation figure of FIG. 15 case of the operation of the jitter signal generator 11 used for the equipment of this invention.

Number 66 is maximum value of a counter 68, and 67 is zero value of a counter 68. Using FIG. 15 and FIG. 16, operation of the jitter signal generator 11 of this case of the operation is explained.

At a counter 68, first, the output and record clock of a high frequency oscillator, Or if clocks, such as a system clock oscillated with crystal, are inputted, a rise count is carried out with a clock at first, the value goes up and maximum 66 is reached

It overflows with the following clock, and becomes zero value, and it is repeated, from a counter 68, the saw blade-like wave of a digital signal is outputted, it is changed into the saw blade-like wave of an analog signal with the DAC 65, and the saw blade-like wave signal is used as a jitter signal.

Here, the DAC 65 used for FIG. 13 and FIG. 15 may be a DAC of a 1-bit input and 2 value output.

Moreover, in order to divide a clock at a counter, to be able to use the signal through a digital analog low-pass passage filter as a jitter signal as composition of the jitter signal generator 11 and to avoid the step in every bit of the output of the DAC 65, a low-pass passage filter can be added and a smooth jitter signal can also be acquired.

Moreover, after carrying out false random number conversion of the output of a counter 68, it is also possible by inputting into the DAC 65 to make move of frequency random and to eliminate the influence of the beat by a regular signal.

This invention is applicable to the equipment which drives the equipment or the laser light emitting element which drives a laser light emitting element, and if it is what carried out high frequency superposition at the drive current, and the thing which carries out a switching drive, it is applicable not only to optical disk drive equipment but all the uses of a communication apparatus, the equipment for data reading, etc.

1. A laser drive unit, comprising:
a laser driver which supplies current to laser element,
a HFM (High Frequency Module) oscillator which reduces laser mode hopping noise by superimposing a high frequency signal on the current of said laser driver, and
a jitter addition circuit which gives frequency jitter to the high frequency signal from said HFM oscillator.

2. An optical pick-up head, comprising:
an optical system with laser element and objective lens which focuses on an optical disc,
a laser driver which supplies current to said laser element,
a HFM oscillator to reduce laser mode hopping noise by superimposing a high frequency signal on the current of said laser driver, and
a jitter addition circuit which gives frequency jitter to the high frequency signal from said HFM oscillator.

3. An optical disc drive equipment, comprising:
an optical system with laser element and objective lens which focuses on an optical disc,
a optical detector which monitors amount of luminescence of said laser element,
a laser driver which supplies current to laser element,
a control circuit which controls current value of said laser driver according to the output of said optical detector,
a HFM oscillator to reduce laser mode hopping noise by superimposing a high frequency signal on the current of said laser driver, and
a jitter addition circuit which gives frequency jitter to the high frequency signal from said HFM oscillator.

4. A laser drive system, a laser drive unit as in claim 1, an optical pick-up head as in claim 2, or an optical disc drive equipment as in claim 3, further comprising:
an oscillator which has variable capacitance diode, and the oscillation frequency is able to be changed by the capacitance of said variable capacitance diode, and said jitter addition circuit modulate the oscillation frequency of said HFM oscillator by adding the jitter voltage to said variable capacitance diode.

5. A laser drive system, a laser drive unit as in claim 1, an optical pick-up head as in claim 2, or an optical disc drive equipment in claim 3, further comprising:
an oscillator which consists of odd inverters which combined input and output in a shape of a ring, and the oscillation frequency is able to be changed by changing one of power voltage and power current for said inverters, and said jitter addition circuit modulate the oscillation frequency of said HFM oscillator by adding the jitter to one of power voltage and power current for said inverters.

6. A laser drive system, a laser drive unit as in claim 1, an optical pick-up head as in claim 2, or an optical disc drive equipment as in claim 3, further comprising: an oscillator which has two FETs (field effect transistor), two current sauce and capacitor, and each gate of said FETs are connected with drain each other, and said capacitor is connected between each sauce of said FETs, and said jitter addition circuit gives a jitter to said current sauce.

7. A laser drive system, a laser drive unit as in claim 1, an optical pick-up head as in claim 2, or an optical disc drive equipment as in claim 3, further comprising:
an oscillator which has two bipolar transistors, two current sauce and capacitor, and each base of said bipolar transistors are connected with collector each other, and said capacitor is connected between each sauce of said emitter, and said jitter addition circuit gives a jitter to said current sauce.

8. A laser drive unit, comprising:
a laser driver which supplies current to laser element,
a write-strategy generating circuit which generates the writing pulse for recording,
a jitter addition circuit which gives a jitter to said writing pulse.

9. An optical pick-up head, comprising:
an optical system with laser element and objective lens which focuses on an optical disc,
a optical detector which monitors amount of luminescence of said laser element,
a laser driver which supplies current to said laser element,
a control circuit which controls current value of said laser driver according to the output of said optical detector,
a write-strategy generating circuit which generates the writing pulse for recording, and
a jitter addition circuit which gives a jitter to said writing pulse.

10. An optical disc drive equipment, comprising:
an optical system with laser element and objective lens which focuses on an optical disc,
a optical detector which monitors amount of luminescence of said laser element,
a laser driver which supplies current to laser element,
a control circuit which controls current value of said laser driver according to the output of said optical detector,
a write-strategy generating circuit which generates the writing pulse for recording, and
a jitter addition circuit which gives a jitter to said writing pulse.

11. A laser drive system, a laser drive unit as in claim 8, an optical pick-up head as in claim 9, or an optical disc drive equipment as in claim 10, further comprising:
PLL (phase locked loop) which generates clock as same or multiple frequency as writing clock for write-strategy generating circuit, and said jitter addition circuit carrying out the frequency modulation of the clock for said write-strategy generating circuit by adding jitter to a loop filter of said PLL.

12. A laser drive system, a laser drive unit as in claim 8, an optical pick-up head as in claim 9, or an optical disc drive equipment as in claim 10, further comprising:
a delay line in order to generate a write-strategy signal, and said jitter addition circuit carrying out the frequency modulation of the output of said delay line by giving jitter to power supply voltage or power supply current of said delay line.

13. A laser drive system, a laser drive unit as in claim 8, an optical pick-up head as in claim 9, or an optical disc drive equipment as in claim 10, further comprising:
a PLL which generates writing clock from track wobble signal of optical disc, and said jitter addition circuit carrying out the frequency modulation of the clock for said write-strategy generating circuit by adding jitter to a loop filter of said PLL.

14. A laser drive system, a laser drive unit as in claim 8, an optical pick-up head as in claim 9, or an optical disc drive equipment as in claim 10, further comprising:
a jitter signal generator which has counter to count clock and a digital-to-analog converter to change into an analog value from a value of said counter and applying output of said jitter signal generator to said jitter addition circuit.
